(19) United States
(12) Patent Application Publication
(10) Pub. No.: US 2013/0307724 A1
(43) Pub. Date: Nov. 21, 2013

(54) Apparatus And Method For Generating GPS Time

(71) Applicants: Cheonjoong Kim, Daejeon (KR); Heongwon Park, Daejeon (KR); Hyunseok Kim, Sejong-si (KR)

(72) Inventors: Cheonjoong Kim, Daejeon (KR); Heongwon Park, Daejeon (KR); Hyunseok Kim, Sejong-si (KR)

(73) Assignee: Agency for Defense Development

(21) Appl. No.: 13/981,639

(22) PCT Filed: Jan. 11, 2012
(86) PCT No.: PCT/KR12/00260

§ 371 Date: Jul. 25, 2013

(30) Foreign Application Priority Data
Jan. 31, 2011 (KR) 10-2011-0009572

(51) Int. Cl. G01S 19/33

(52) U.S. Cl. CPC G01S 19/33
USPC 342/357.73

(57) ABSTRACT

Disclosed therein is an apparatus for generating a GPS (Global Positioning System) time that includes: a storing portion for storing a first GPS time corresponding to a 1PPS (Pulse Per Second) signal generated from a GPS receiver for synchronization with an INS (Inertial Navigation System); and a GPS time calculating portion for, upon reception of the 1PPS signal from the GPS receiver, adding a previous first GPS time stored in the storing portion and a period of the 1PPS signal to compute a second GPS time, and storing the first GPS time corresponding to the received 1PPS signal in the storing portion, thereby generating an accurate GPS time at a generation point of the 1PPS signal.

### TECHNICAL FIELD

The present invention relates to an apparatus and method for generating GPS time, and more particularly, to an apparatus and method for generating GPS time that is used for synchronization in an integrated navigation system having both GPS (Global Positioning System) receiver and INS (Inertial Navigation System).

### BACKGROUND ART

Reference navigation information is required in order to evaluate the navigation performance of the GPS receiver and the INS. And the DGPS (Differential Global Positioning System) is used for generating the reference navigation information.

To evaluate the navigation performance of the INS and the integrated navigation system by way of the DGPS, it is necessary to precisely synchronize the GPS time of the DGPS and the target device to be evaluated. But, the GPS time transferred from the GPS receiver is delayed by the internal processing time of the GPS receiver, when the navigation information is generated in synchronization with reference to the time at which the INS receives the GPS time, it cannot be synchronized with the navigation information that is in synchronization with the DGPS having accurate GPS time information. It is therefore difficult to accurately evaluate the navigation performance. This problem results from the fact that the integrated navigation system cannot generate an accurate GPS time for use in synchronization.

### DISCLOSURE OF INVENTION

### Technical Problem

It is an object of the present invention to provide an apparatus and a method for generating a GPS time that can be used for synchronization in an integrated navigation system having both INS and GPS receiver.

It is to be understood that the present invention is not limited in its technical solutions to the above-mentioned technical solutions, and that other solutions not mentioned in this specification will be understood to those skilled in the art from the description that follows.

### Solution to Problem

To achieve the above object, the present invention provides an apparatus for generating a GPS (Global Positioning System) time that includes: a storing portion for storing a first GPS time corresponding to a 1PPS (Pulse Per Second) signal generated from a GPS receiver for synchronization with an INS (Inertial Navigation System); and a GPS time calculating portion for, upon reception of the 1PPS signal from the GPS receiver, adding a previous first GPS time stored in the storing portion and a period of the 1PPS signal to compute a second GPS time, and storing the first GPS time corresponding to the received 1PPS signal in the storing portion.

The GPS time calculating portion computes the period of the 1PPS signal.

Also, the apparatus further includes: a detailed GPS time calculating portion for designating the second GPS time as an initial value, cumulatively adding a navigation update period of the INS to the initial value in every navigation update period to compute a third GPS time.

The storing portion further stores the third GPS time.

The second GPS time is computed in every period of the 1PPS signal.

In another embodiment of the present invention, there is provided an apparatus for time-synchronizing the navigation information that includes: a GPS time generating portion; and a synchronizing portion. The GPS time generating portion includes: a storing portion for storing a first GPS (Global Positioning System) time corresponding to a 1PPS (Pulse Per Second) signal generated from a GPS receiver for synchronization with an INS (Inertial Navigation System); a GPS time calculating portion for, upon reception of the 1PPS signal from the GPS receiver, adding a previous first GPS time stored in the storing portion and a period of the 1PPS to compute a second GPS time in every period of the 1PPS signal, and storing the first GPS time corresponding to the received 1PPS signal in the storing portion; and a detailed GPS time calculating portion for designating the second GPS time as an initial value, cumulatively adding a navigation update period of the INS to the initial value in every navigation update period to compute a third GPS time, and storing the third GPS time in the storing portion. The synchronizing portion is for using the third GPS time stored in the storing portion to synchronize reference navigation information generated from a reference navigation system and navigation information of the GPS receiver and the INS.

The synchronizing portion further synchronizes navigation information of an auxiliary sensor used for error correction of the INS.

In further another embodiment of the present invention, there is provided a system for evaluating an integrated navigation system that includes: the apparatus for time-synchronizing the navigation information; and an evaluation apparatus for using the reference navigation information and the individual navigation information synchronized by the synchronizing portion to evaluate a target device to be synchronized by the synchronizing portion.

In still another embodiment of the present invention, there is provided a method for generating a GPS time that includes comprising the steps of: receiving a 1PPS signal from a GPS receiver; upon reception of the 1PPS signal, extracting a previous first GPS time stored in a storing portion; adding the extracted first GPS time and a period of the 1PPS signal to compute a second GPS time; receiving the first GPS time corresponding to the received 1PPS signal, and storing the first GPS time in the storing portion.

The method further includes the step of: calculating the period of the received 1PPS signal, after the step of receiving the 1PPS signal and prior to the step of calculating the second GPS time.

The method further includes the step of: after the step of calculating the second GPS time, designating the second GPS time as an initial value, cumulatively adding a navigation update period of an INS to the initial value in every navigation update to compute a third GPS time.

The method further includes the step of: after the step of calculating the third GPS time, storing the third GPS time.

The method for generating a GPS time may be recorded on a computer-readable record medium in a program.

### ADVANTAGEOUS EFFECTS OF INVENTION

As described above, the apparatus and a method for generating a GPS time according to the present invention can compute an accurate GPS time at a generation point of a 1PPS signal by using a 1PPS signal periodically generated from the GPS receiver for time synchronization and a time-delayed GPS time transmitted to the INS.

The calculated GPS time is the GPS time at a generation point of a 1PPS signal, thus making it possible to acquire synchronization with a DGPS using the GPS time with reliability.

The calculated GPS time and the navigation update period of the INS can be used to generate a GPS time needed for the time synchronization in every navigation update period. In this manner, it is possible to synchronize various auxiliary sensors equipped on an integrated navigation system as well as the DGPS with the GPS time.

As a result, synchronization can be achieved with reliability between the DGPS used as a reference in performance evaluation of the integrated navigation system and the individual target components to be evaluated, thereby realizing reliable evaluation using a reference navigation system.

### BRIEF DESCRIPTION OF DRAWINGS

FIG. 1 is a block diagram showing an apparatus for generating a GPS time according to the present invention.

FIG. 2 is a schematic diagram showing the individual signals related to the apparatus for generating a GPS time according to the present invention.

FIG. 3 is a block diagram showing an apparatus for time-synchronizing the navigation information according to the present invention.

FIG. 4 is a block diagram showing a system for evaluating an integrated navigation system according to the present invention.

FIG. 5 is a flow chart showing a method for generating a GPS time according to the present invention.

### MODE FOR THE INVENTION

Hereinafter, reference will be now made in detail to an apparatus and a method for generating a GPS time according to the present invention with reference to the attached drawings.

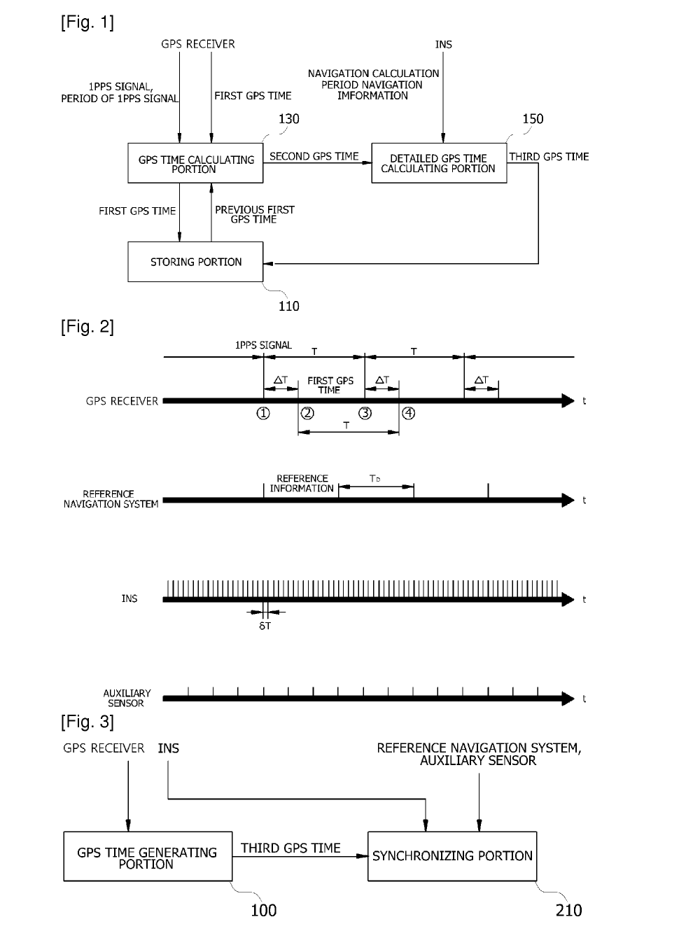

FIG. 1 is a block diagram showing an apparatus for generating a GPS time according to the present invention.

The apparatus for generating a GPS time as shown in FIG. 1 includes: a storing portion 110 for storing a first GPS time corresponding to a 1PPS (Pulse Per Second) signal generated from a GPS receiver for use in the synchronization with an INS; and a GPS time calculating portion 130 for calculating a second GPS time by adding the previous first GPS time stored in the storing portion and the period of the 1PPS signal when the 1 PPS signal from the GPS receiver is received, and storing the first GPS time corresponding to the received 1PPS signal in the storing portion.

The INS (Inertial Navigation System) is a navigation system that is used on air vehicles such as long-range rockets, aircrafts, or the like to compute the air vehicle's current location. The INS uses gyroscopes to prepare a reference table for maintaining a constant attitude in inertial space, and precise accelerometers built in combination with the gyroscopes to measure an acceleration of air vehicles on a reference table. The gyroscope/accelerometer-equipped INS is built on air vehicles. By using the INS, the air vehicle can measure its own flight distance by integrating 3-axis acceleration from the launching time to a designated time twice, and thereby compute its current position. Characteristically, the INS can determine its own position without any other external aids and is not affected by external interruptions. The INS was initially developed as a missile guidance system (with a guidance time of several minutes) and improved in precision to be appropriate for aircrafts of which the flight duration is around 10 hours. The INS has a positioning error of about 10 km over a flight distance of several thousand kilometers, which is a considerably small error but may cause serious problems in a situation that requires a precise navigation. To minimize such positioning errors, the INS can be used with a navigation aid, and the present invention uses the GPS receiver as the navigation aid. The INS can also adopt auxiliary sensors such as altimeters, vision sensor, and so forth. Here, a combination of the INS, navigation aids, and auxiliary sensors used for error correction of the INS is referred to as an “integrated navigation system”.

The GPS (Global Positioning System) is a radio navigation system that uses a propagation delay time upon receiving radio signals from navigation satellites of which accurate positions are known, to compute the pseudo-range distance to each satellite and determine its position. The navigation information of the GPS is theoretically determined from the radio signals received from at least three satellites according to triangulation. For this, there needs an assumption that the time information computed in the receiver is in synchronization with the time information in the satellites. It is impracticable to provide the receiver with an expensive atomic clock that is built on the navigation satellites. Instead, the time difference between a receiver clock and a satellite clock is designated as an unknown value, and four simultaneous equations are solved to compute the vehicle's navigation information and the time difference between the two clocks. At least four satellites are thus necessary for the GPS to determine its own position. As the importance of the GPS increases progressively in recent years, the United States and the Russian Federation are working on the modernization of the GPS, GLONASS systems that are now in operation, and the European Union is building up its own satellite navigation system called “Galileo”. Other countries such as China, Japan, India, etc. are also trying to develop their own satellite navigation systems. It is therefore predictable that in the future, more accurate positioning and time information will be acquired by receiving multi-satellite navigation signals.

The GPS time, which is time information computed through successive satellite positioning with four satellite navigation signals as described above, is equivalent in precision to the time information of the navigation satellites. As a result, the time information can be acquired with the same precision as the time information of the navigation satellites, when the GPS time is available anywhere in the world. Therefore, the GPS time is used for the purpose of time synchronization in a various range of applications.

The GPS time is time information at the time that the GPS receiver receives the navigation signals from the navigation satellites. But the GPS time output from the GPS receiver is delayed by a navigation signal processing time ΔT in the GPS receiver receiving the navigation signals. To eliminate the delay, or make it known to the other systems, the GPS receiver generates an 1PPS (Pulse Per Second) signal that is a hardware signal representing a point of time at which the navigation signal from the navigation satellites is received. Here, the point of time at which the 1PPS signal is generated is the same as the point of time at which the navigation signal is received.

The 1PPS signal is normally output as a pulsesignal and shared in the integrated navigation system in a manner of hardware (i.e., signal transmission through cables, etc.) for time synchronization.

The reference navigation information is necessary for the performance evaluation of the integrated navigation system. The DGPS (Differential Global Positioning System) generates the reference navigation information. The DGPS is a system that performs the relative positioning with at least two GPS receivers to precisely compute the range correction of the individual navigation satellites and then use it in the error correction of the GPS receiver modules on the site. The GPS receiver built on the site, namely, an air vehicle equipped with an integrated navigation system is called “first DGPS module” as used herein. Another GPS receiver that is then called “second DGPS module” is provided at a location where the precise position can be known and then used to correct the error of the first DGPS. Accordingly, the first DGPS computes accurate navigation information, which is used as the reference navigation information. The second DGPS cannot use the 1PPS signal of the GPS receiver provided in the integrated navigation system, and thus the reference navigation information generated by the first DGPS cannot be synchronized with the navigation information generated by the integrated navigation system to be evaluated. In reference, the second DGPS can substitute the GPS receiver with a navigation system such as a radar. These systems including the first DGPS will be all referred to as “reference navigation system”.

The first and second DGPS is synchronized with the GPS timein order to compute accurate navigation information, so the navigation information of the integrated navigation system to be evaluated also needs to be synchronized with the GPS time. Here, the navigation information of the integrated navigation system to be synchronized includes the navigation information of the GPS receiver and the auxiliary sensor. The auxiliary sensor may include a time synchronization means for acquiring synchronization with the INS without using the 1PPS signal. Here, the time synchronization means also needs to be synchronized with the GPS time.

The processing delay time ΔT of the GPS receiver is problematic in the course of synchronization with the GPS time. In other words, the GPS time of the GPS receiver is not output at a generation point of the 1PPS signal but delayed by ΔT, so it cannot synchronize with the reference navigation information that is synchronized with GPS time. To solve this problem, the apparatus for generating a GPS time according to the present invention includes the storing portion 100 and the GPS time calculating portion 130.

The storing portion 110 stores a first GPS time corresponding to the 1PPS signal.

The first GPS time, which is a GPS time output from the GPS receiver, is delayed and output late by the navigation signal processing time ΔT in the GPS receiver, relative to the time that it represents.

The term “corresponding to” as used herein means that “generated by the same navigation signal as”. Thus, “the first GPS time corresponding to the 1PPS signal” implies that the first GPS time is not generated at a generation point of the 1PPS signal (i.e., the navigation signal reception time) but generated by the same navigation signal.

Upon receiving the 1PPS signal, the GPS time calculating portion 130 extracts the previous first GPS time as stored in the storing portion 110. Suppose that the current first GPS time is the n-th first GPS time, for example; then ‘the previous first GPS time’ is the (n−1)-th first GPS time.

The GPS time calculating portion 130 adds the extracted first GPS time and the period of the 1PPS signal. The sum is the second GPS time. The generation point of the second GPS time is the same as the point of the 1PPS signal reception time. Accordingly, the generation point of the second GPS time is equal to the generation point of the 1PPS signal at the GPS receiver, namely, the point of the navigation information reception time.

The GPS time calculating portion 130 stores the first GPS time corresponding to the received 1PPS signal in the storing portion 130. Here, the first GPS time corresponding to the 1PPS signal is received after the generation of the second GPS time because of the processing delay time of the GPS receiver.

For this, the GPS time calculating portion necessarily receives the 1PPS signal, the period of the 1PPS signal, and the first GPS time from the GPS receiver.

The GPS time calculating portion can compute the period of the 1PPS signal from the received 1PPS signal. In this manner, the GPS receiver does not have to send the period of the 1PPS signal, and thus has no need of providing a means for computing the period of the 1PPS signal. Of course, a plurality of the 1PPS signals needs to be transmitted in time series clockwise order to compute the period of the 1PPS signal.

There is assumably no time difference between the generation point of 1PPS signal at the GPS receiver and the point of 1PPS signal reception at the GPS time calculating portion. Thus the second GPS time computed by the GPS time calculating portion is a GPS time that is generated at the point of the 1PPS signal reception time, namely, the generation point of the 1PPS signal, which will be described as follows with reference to FIG. 2.

FIG. 2 is a schematic showing the respective signals related to the apparatus for generating a GPS time according to the present invention.

The GPS receiver generates a 1PPS signal with a defined period T. The period T is an accurate value through the correction using the navigation signal of the navigation satellites. When the 1PPS signal is generated at time \textcircled{3}, the first GPS time corresponding to the 1PPS signal is delayed by ΔT and output at time \textcircled{4}. Though the first GPS time is output at time \textcircled{4}, its value represents the time \textcircled{3}, since the target signal is the navigation signal at time \textcircled{3}. But, The first GPS time output later at time \textcircled{4} is unknown at time \textcircled{3}. The storing portion stores the first GPS time at the past time \textcircled{2}. The first GPS time that is output at time \textcircled{2} represents the time \textcircled{1}. Referring to FIG. 2, adding the period T of the 1PPS signal to the time \textcircled{1} result in the time \textcircled{3}. Likewise, adding the period T of the 1PPS signal stored in storage unit at the time \textcircled{2} to the first GPS time compute the GPS time of \textcircled{3}. The resultant GPS time is a second GPS time, which represents the time \textcircled{3} and is generated at time \textcircled{3}. For this, the period T of the 1PPS signal is constant.

Accordingly, the GPS time calculating portion of the present invention can generate the accurate GPS time at each generation point of the 1PPS signal. The reference navigation system uses the GPS time to acquire synchronization between its two modules. Therefore GPS time can be used to synchronize the reference navigation information of the reference navigation system with the navigation information of the integrated navigation system. If necessary, the GPS time calculating portion stores the second GPS time in the storing portion 110. The second GPS time may be computed each time of generating the 1PPS signal.

On the other hand, an appropriate correction is necessary when a period TD of the reference navigation information differs from the period T of the 1PPS of the GPS receiver, as shown in FIG. 2. Also, the reference navigation information needs to effectively synchronize with the navigation information of the INS or the auxiliary sensor. For this, the present invention uses a detailed GPS time calculating portion 150.

The detailed GPS time calculating portion 150 generates a GPS time in narrow intervals using the second GPS time of the GPS time calculating portion 130 as an initial value. The densely generated GPS time is generated according to the navigation update period of the INS.

For example, the detailed GPS time calculating portion 150 designates the second GPS time as an initial value, and cumulatively adds the navigation update period δT of the INS to the initial value in every navigation update period δT to compute a third GPS time. The detailed GPS time calculating portion gets the navigation update period information directly out of the INS, or computes the navigation update period from the navigation information generated in every navigation update period.

Referring to FIG. 2, the INS generates navigation information in the navigation update period δT that is considerably short. The time information of the INS is excellent in reliability for a short term navigation. According to this feature of the INS, the GPS time can be generated in every navigation update period δT of the INS. As for a long term navigation that causes errors because of the characteristics of the INS, the second GPS time is used to correct the navigation update period δT.

For this, the detailed navigation time calculating portion 150 receives the navigation update period δT from the INS, and the second GPS time from the GPS time calculating portion. Upon reception of the second GPS time, the current time is initialized as the second GPS time and then cumulatively increased by the navigation update period δT. The sum is the third GPS time, and the number of the sums is equal to the number of the navigation information generated in every navigation update period of the INS. The third GPS time thus obtained may be stored in the storing portion 110 for synchronization with various components of the integrated navigation system. Otherwise, the detailed GPS time calculating portion 150 may receive the navigation information from the INS to compute the navigation update period δT.

There may be a deterioration of the reliability of the third GPS time when the initialization interval using the second GPS time is long. Thus the second GPS time computed by the GPS time calculating portion may be calculated in every period of the 1PPS signal. In this manner, the detailed GPS time calculating portion corrects the third GPS time that is increased by the navigation update period δT in every period of the 1PPS signal, resulting in enhanced reliability.

The third GPS time stored in the storing portion 110 is the GPS time densely generated. This feature of the third GPS time makes it easier to synchronize with the INS having the same period of the first GPS time, and the reference navigation system or the auxiliary sensor having a greater period than the third GPS time.

FIG. 3 is a block diagram showing an apparatus for time-synchronizing the navigation information according to the present invention.

The apparatus for time-synchronizing the navigation information according to the present invention as shown in FIG. 3 includes a GPS time generating portion 100, and a synchronizing portion 210.

The GPS time generating portion 100 may be the apparatus for generating a GPS time according to the present invention as illustrated in FIG. 1.

The GPS time generating portion 100 includes: a storing portion 110 for storing a first GPS time corresponding to an 1PPS (Pulse Per Second) signal generated by a GPS receiver for synchronization with an INS; a GPS time calculating portion 130 for, upon receiving the 1PPS signal from the GPS receiver, adding previous first GPS time stored in the storing portion 110 and the period of the 1PPS signal to compute a second GPS time in every period of the 1PPS signal, and storing the first GPS time corresponding to the received 1PPS signal in the storing portion 110; and a detailed GPS time calculating portion 150 for designating the second GPS time as an initial value, cumulatively adding a navigation update period of the INS to the initial value in every navigation update period to compute a third GPS time, and storing the third GPS time in the storing portion 110.

The synchronizing portion 210 uses the third GPS time stored in the storing portion 110 to acquire synchronization among the reference navigation information generated from a reference navigation system, the navigation information of the GPS receiver, and the navigation information of the INS.

The synchronizing portion 210 may also synchronize the information of auxiliary sensors used for error correction of the INS.

Conventionally, the reference navigation information is difficult to synchronize because of the characteristic of the reference navigation system that 1PPS signals cannot be used. However, according to the present invention, the GPS time at a generation point of the 1PPS signal can be generated at a generation point of the 1PPS signal, so it can synchronize with the reference navigation system. It is therefore possible to evaluate the integrated navigation system with reliability.

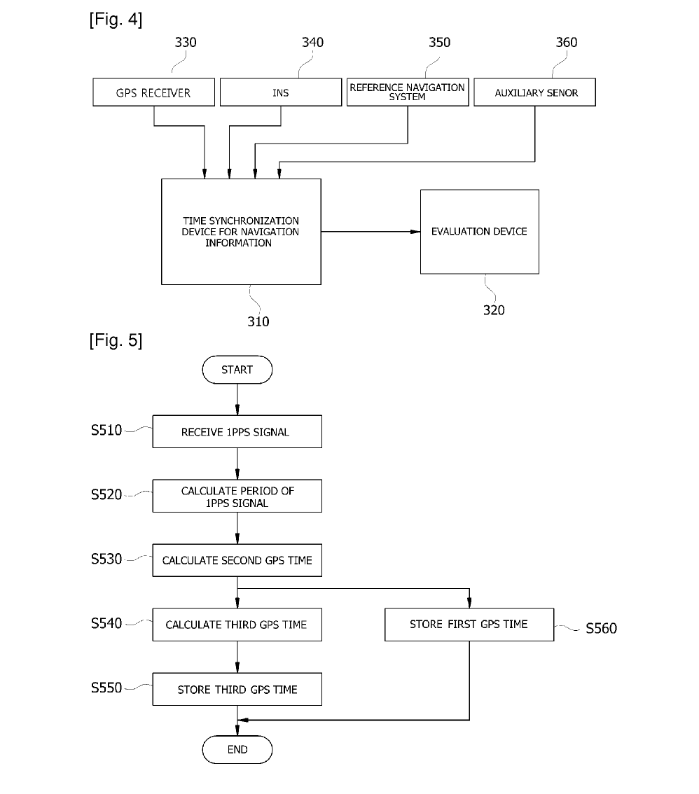

FIG. 4 is a block diagram of a system for evaluating an integrated navigation system according to the present invention.

The system for evaluating an integrated system according to the present invention as shown in FIG. 4 includes: a time synchronization device 310 for synchronizing navigation information; and an evaluation device 320 for evaluating a target device of the synchronizing portion using reference navigation information and other navigation information to be synchronized by a synchronizing portion provided in the time synchronization device for navigation information.

The time synchronization device 310 for navigation information is analogous to the apparatus for time-synchronizing the navigation information as described with reference to FIG. 3.

The evaluation device 320 uses the reference navigation system 350 as a reference to evaluate a target equipment such as INS 340, GPS receiver 330, auxiliary sensor 360 or the like that constitute an integrated navigation system. For evaluation, the navigation information of the individual target equipment needs to synchronize with the reference navigation information of the reference navigation system. The time synchronization device 310 for navigation information performs this synchronization process.

The evaluation device 320 may also evaluate a means for interfacing the navigation information of the individual target device.

The synchronization-related problem in the prior art makes it difficult to use the reference navigation system; contrarily, such a problem is overcome through the time synchronization device 310 for navigation information according to the present invention.

FIG. 5 is a flow chart showing a method for generating a GPS time according to the present invention.

The method for generating a GPS time according to the present invention as shown in FIG. 5 may be described by way of the operation of the apparatus for generating a GPS time as shown in FIG. 1.

Firstly, an 1PPS signal is received from a GPS receiver, in step S510.

Upon reception of the 1PPS signal, the previous first GPS time stored in the storing portion is extracted and then added to the period of the 1PPS signal to give a second GPS time, in step S530.

The first GPS time corresponding to the received 1PPS signal is received and stored in the storing portion, in step S560. Here, the first GPS time corresponding to the received 1PPS signal is delayed by T and then received. Because the second GPS time is computed at the reception time of the 1PPS signal, the first GPS time is stored after the computation of the second GPS time.

The method may further include a step S520 of calculating the period of the received 1PPS signal, after the step S510 of receiving the 1PPS signal or prior to the step S530 of calculating the second GPS time. The GPS time calculating portion 130 performs the above-described procedures.

Secondly, after the step S530 of calculating the second GPS time, the second GPS time is designated as an initial time, and the navigation update period of the INS is cumulatively added to the initial value in every navigation update period to give a third GPS time, in step S540. The third GPS time may be stored in step S550 after the step of calculating the third GPS time. The detailed GPS time calculating portion 150 performs the above-described procedures.

On the other hand, the method for generating a GPS time according to the present invention as illustrated in FIG. 5 may be programmed on a computer-readable record medium.

As described above, although the invention has been described with preferred embodiments, it is to be understood that variations and modifications may be resorted to as will be apparent to those skilled in the art without changing the technical ideas and essential features. Thus, the embodiments are only for illustrative purposes and are not intended to limit the present invention. It is to be understood that modifications and variations of the present invention may be resorted to without departing from the technical idea and scope of the present invention as those skilled in the art readily understand. Such modifications, variations and all equivalent relationships are considered to be within the scope of the invention and the appended claims.

### INDUSTRIAL APPLICABILITY

The present invention is applicable to synchronization of integrated navigation systems.

Particularly, the present invention is useful in the case there is a need of using an external device such as a reference navigation system.

In this manner, the present invention provides a means for reliable evaluation on integrated navigation systems using a reference navigation system.

1. An apparatus for generating a GPS (Global Positioning System) time, comprising:
a storing portion for storing a first GPS time corresponding to a 1 PPS (Pulse Per Second) signal generated from a GPS receiver for synchronization with an INS (Inertial Navigation System); and
a GPS time calculating portion for, upon reception of the 1 PPS signal from the GPS receiver, adding a previous first GPS time stored in the storing portion and a period of the 1 PPS signal to compute a second GPS time, and storing the first GPS time corresponding to the received 1 PPS signal in the storing portion.

2. The apparatus as claimed in claim 1, wherein the GPS time calculating portion computes the period of the 1 PPS signal from the 1 PPS signal.

3. The apparatus as claimed in claim 1, further comprising:
a detailed GPS time calculating portion for designating the second GPS time as an initial value, cumulatively adding a navigation update period of the INS to the initial value in every navigation update period to compute a third GPS time.

4. The apparatus as claimed in claim 3, wherein the storing portion further stores the third GPS time.

5. The apparatus as claimed in claim 4, wherein the second GPS time is computed in every period of the 1 PPS signal.

6. An apparatus for time-synchronizing the navigation information, comprising:
a GPS time generating portion; and
a synchronizing portion, wherein the GPS time generating portion comprises:
a storing portion for storing a first GPS (Global Positioning System) time corresponding to a 1 PPS (Pulse Per Second) signal generated from a GPS receiver for synchronization with an INS (Inertial Navigation System);
a GPS time calculating portion for, upon reception of the 1 PPS signal from the GPS receiver, adding a previous first GPS time stored in the storing portion and a period of the 1 PPS to compute a second GPS time in every period of the 1 PPS signal, and storing the first GPS time corresponding to the received 1 PPS signal in the storing portion; and
a detailed GPS time calculating portion for designating the second GPS time as an initial value, cumulatively adding a navigation update period of the INS to the initial value in every navigation update period to compute a third GPS time, and storing the third GPS time in the storing portion,
wherein the synchronizing portion is for using the third GPS time stored in the storing portion to synchronize reference navigation information generated from a reference navigation system and navigation information of the GPS receiver and the INS.

7. The apparatus as claimed in claim 6, wherein the synchronizing portion further synchronizes navigation information of an auxiliary sensor for error correction of the INS.

8. A system for evaluating an integrated navigation system, comprising:
the apparatus for time-synchronizing the navigation information as claimed in claim 6; and
an evaluation apparatus for using the reference navigation information and the individual navigation information synchronized by the synchronizing portion to evaluate a target device to be synchronized by the synchronizing portion.

9. A method for generating a GPS time, comprising the steps of:
receiving a 1 PPS signal from a GPS receiver;
upon reception of the 1 PPS signal, extracting a previous first GPS time stored in a storing portion;
adding the extracted first GPS time and a period of the 1 PPS signal to compute a second GPS time; and
receiving the first GPS time corresponding to the received 1 PPS signal, and storing the first GPS time in the storing portion.

10. The method as claimed in claim 9, further comprising the step of:
calculating the period of the received 1 PPS signal, after the step of receiving the 1 PPS signal and prior to the step of calculating the second GPS time.

11. The method as claimed in claim 9, further comprising the step of:
after the step of calculating the second GPS time,
designating the second GPS time as an initial value, cumulatively adding a navigation update period of an INS to the initial value in every navigation update period to compute a third GPS time.

12. The method as claimed in claim 11, further comprising the step of:
after the step of calculating the third GPS time,
storing the third GPS time.

13. A computer-readable record medium, recording the method as claimed in claim 9 in a program.

14. The system as claimed in claim 8, wherein the synchronizing portion further synchronizes navigation information of an auxiliary sensor for error correction of the INS.
